(19) United States
(12) Patent Application Publication
(10) Pub. No.: US 2021/0047910 A1
(43) Pub. Date: Feb. 18, 2021

(54) LEARNING BASED BAYESIAN OPTIMIZATION FOR OPTIMIZING CONTROLLABLE DRILLING PARAMETERS

(71) Applicant: Landmark Graphics Corporation, Houston, TX (US)

(72) Inventors: Srinath MADASU, Houston, TX (US); Keshava Prasad RANGARAJAN, Sugar Land, TX (US)

(21) Appl. No.: 17/047,230

(22) PCT Filed: May 9, 2018
(86) PCT No.: PCT/US2018/031757

§ 371 Date: Oct. 13, 2020

(51) Int. Cl. E21B 44/06; E21B 45/00; E21B 21/08; G06N 3/04; G06N 20/10

(52) U.S. Cl. CPC E21B 44/06; E21B 45/00; E21B 21/08; E21B 2200/22; G06N 20/10; E21B 2200/20; G06N 3/04

(57) ABSTRACT

A method for optimizing real time drilling with learning uses a multi-layer Deep Neural Network (DNN) built from input drilling data. A plurality of drilling parameter features is extracted using the DNN. A linear regression model is built based on the extracted plurality of drilling parameter features. The linear regression model is applied to predict one or more drilling parameters.

### TECHNICAL FIELD OF THE INVENTION

The embodiments disclosed herein generally relate to earth formation drilling operations and, more particularly, to Bayesian optimization for optimizing controllable drilling parameters.

### BACKGROUND OF THE INVENTION

In drilling operations, typical drilling processes are relatively complex and involve considerable expense. There is a continual effort in the industry to develop improvements in safety, cost minimization, and efficiency, particularly with respect to hydrocarbon reservoir characterization and drilling optimization. Nonetheless, there remains a need for more efficient, improved and optimized drilling processes.

### BRIEF DESCRIPTION OF THE SEVERAL VIEWS OF THE DRAWING

For a more complete understanding of the disclosed embodiments, and for further advantages thereof, reference is now made to the following description taken in conjunction with the accompanying drawings in which:

FIG. 1 is a diagram of a drilling system, in accordance with certain embodiments of the present disclosure;

FIG. 2 is a flow diagram for optimizing controllable drilling parameters using a combination of deep neural network and a regressor performed using the drilling system of FIG. 1, in accordance with an embodiment of the present disclosure;

FIG. 3A is a schematic illustrating one embodiment of a deep neural network, in accordance with an embodiment of the present disclosure;

FIG. 3B depicts schematic representation of connections in stacked LSTM cells constituting a deep Recurrent Neural Network in accordance with an embodiment of the present disclosure; and

FIGS. 4A and 4B illustrate a comparison between actual and predicted best point without and with range constraints, respectively, in accordance with an embodiment of the present disclosure.

### DETAILED DESCRIPTION OF THE DISCLOSED EMBODIMENTS

The following discussion is presented to enable a person skilled in the art to make and use the invention. Various modifications will be readily apparent to those skilled in the art, and the general principles described herein may be applied to embodiments and applications other than those detailed below without departing from the spirit and scope of the disclosed embodiments as defined herein. The disclosed embodiments are not intended to be limited to the particular embodiments shown, but are to be accorded the widest scope consistent with the principles and features disclosed herein.

The term “uphole” as used herein means along the drill string or the hole from the distal end towards the surface, and “downhole” or “bottomhole” as used herein means along the drill string or the hole from the surface towards the distal end.

It will be understood that the term “oil well drilling equipment” or “oil well drilling system” is not intended to limit the use of the equipment and processes described with those terms to drilling an oil well. The terms also encompass drilling natural gas wells or hydrocarbon wells in general. Further, such wells can be used for production, monitoring, or injection in relation to the recovery of hydrocarbons or other materials from the subsurface. This could also include geothermal wells intended to provide a source of heat energy instead of hydrocarbons.

As noted above, there remains a need for more efficient, improved and optimized drilling processes. Embodiments of the present invention provide apparatus and methods for hydrocarbon reservoir characterization and drilling optimization using novel learning based Bayesian Optimization (BO) with range constraints. The disclosed BO method with range constraints predicts optimum controllable parameters required for drilling optimization. Determination of optimal drilling parameters, such as optimal, instantaneous Rate Of Penetration (ROP), Weight On Bit (WOB) and Rotations Per Minute (RPM), are computed for the formation being drilled using the BO method with range constraints, and the drilling parameters are adjusted to the optimal WOB and RPM. The disclosed method provides fast, robust and accurate prediction using discrete data as input.

The disclosed methodology employs a neural network based deep learning technique that aids in fast and efficient computation of required optimum controllable parameters and in further utilizing the parameters for real-time automated control of ROP, RPM, WOB parameters, and the like. The disclosed deep learning technique is fast in part because it does not need an objective function to be provided during pre-training of the neural network. The use of a deep neural network (DNN) in combination with a regressor further aids in fast and efficient computation. In some implementations, the disclosed technique is at least three times faster relative to state-of-the-art Gaussian Process (GP) modeling.

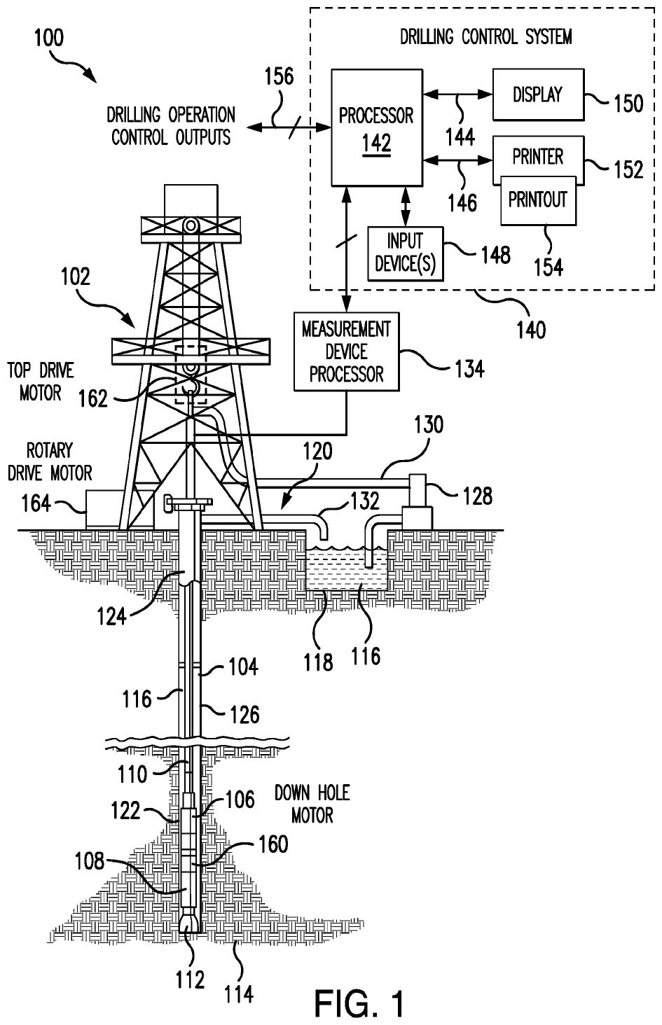

Referring now to FIG. 1, a drilling system 100 includes a drilling rig 102 disposed atop a borehole 104. A logging tool 106 is carried by a sub 108, typically a drill collar, incorporated into a drill string 110 and disposed within the borehole 104. A drill bit 112 is located at the lower end of the drill string 110 and carves a borehole 104 through the earth formations 114. Drilling mud 116 is pumped from a storage reservoir pit 118 near the wellhead 120, down an axial passageway (not illustrated) through the drill string 110, out of apertures in the bit 112 and back to the surface through the annular region 122. Metal casing 124 is positioned in the borehole 104 above the drill bit 112 for maintaining the integrity of an upper portion of the borehole 104.

With reference still to FIG. 1, the annular 122 between the drill stem 110, sub 108, and the sidewalls 126 of the borehole 104 forms the return flow path for the drilling mud. Mud is pumped from the storage pit near the well head 120 by pumping system 128. The mud travels through a mud supply line 130 which is coupled to a central passageway extending throughout the length of the drill string 110. Drilling mud is, in this manner, forced down the drill string 110 and exits into the borehole through apertures in the drill bit 112 for cooling and lubricating the drill bit and carrying the formation cuttings produced during the drilling operation back to the surface. A fluid exhaust conduit 132 is connected from the annular passageway 122 at the well head for conducting the return mud flow from the borehole 104 to the mud pit 118. The drilling mud is typically handled and treated by various apparatus (not shown) such as out gassing units and circulation tanks for maintaining a preselected mud viscosity and consistency.

The logging tool or instrument 106 can be any conventional logging instrument such as acoustic (sometimes referred to as sonic), neutron, gamma ray, density, photoelectric, nuclear magnetic resonance, or any other conventional logging instrument, or combinations thereof, which can be used to measure lithology or porosity of formations surrounding an earth borehole.

Because the logging instrument is embodied in the drill string 110 in FIG. 1, the system is considered to be a measurement while drilling (MWD) system, i.e., it logs while the drilling process is underway. The logging data can be stored in a conventional downhole recorder (not illustrated), which can be accessed at the earth's surface when the drill sting 110 is retrieved, or can be transmitted to the earth's surface using telemetry such as the conventional mud pulse telemetry systems. In either event, the logging data from the logging instrument 106 eventually reaches a surface measurement device processor 134 to allow the data to be processed for use in accordance with the embodiments of the present disclosure as described herein. That is, measurement processor 134 processes the logging data as appropriate for use with the embodiments of the present disclosure.

In addition to MWD instrumentation, wireline logging instrumentation may also be used. That is, wireline logging instrumentation may also be used for logging the formations surrounding the borehole as a function of depth. With wireline instrumentation, a wireline truck (not shown) is typically situated at the surface of a well bore. A wireline logging instrument is suspended in the borehole by a logging cable which passes over a pulley and a depth measurement sleeve. As the logging instrument traverses the borehole, it logs the formations surrounding the borehole as a function of depth. The logging data is transmitted through a logging cable to a processor located at or near the logging truck to process the logging data as appropriate for use with the embodiments of the present disclosure. As with the MWD embodiment of FIG. 1, the wireline instrumentation may include any conventional logging instrumentation which can be used to measure the lithology and/or porosity of formations surrounding an earth borehole, for example, such as acoustic, neutron, gamma ray, density, photoelectric, nuclear magnetic resonance, or any other conventional logging instrument, or combinations thereof, which can be used to measure lithology.

Referring again still to FIG. 1, a drilling control system 140 is shown. The drilling control system 140 includes a prescribed set of geology and drilling mechanics The drilling control system 140 further includes a device generally referred to herein as a processor 142 and comprising any suitable commercially available computer, controller, or data processing apparatus having a processor and a memory device coupled to or otherwise accessible by the processor. The memory device, which may form a part of the processor 142, contains a set of instructions for carrying out the method and apparatus as further described herein. Processor 142 receives input from any suitable input device (or devices) 148. Input device (devices) 148 may include a keyboard, keypad, pointing device, or the like, further including a network interface or other communications interface for receiving input information from a remote computer or database. Processor 142 outputs information signals and/or equipment control commands Output signals can be output to a display device 150 via signal lines 144 for use in generating a display of information contained in the output signals. Output signals can also be output to a printer device 152 for use in generating a printout 154 of information contained in the output signals. Information and/or control signals may also be output via signal lines 156 as necessary, for example, to a remote device for use in controlling one or more various drilling operating parameters of drilling rig 102, further as discussed herein. In other words, a suitable device or means is provided on the drilling system which is responsive to a predicted drilling mechanics output signal for controlling a parameter in an actual drilling of a well bore (or interval) with the drilling system. For example, drilling system may include equipment such as one of the following types of controllable motors selected from a down hole motor 160, a top drive motor 162, or a rotary table motor 164, further in which a given rpm of a respective motor may be remotely controlled. The parameter may also include one or more of the following selected from the group of weight-on-bit, rpm, mud pump flow rate, hydraulics, or any other suitable drilling system control parameter.

Processor 142 is programmed for performing functions as described herein, using programming techniques known in the art. In one embodiment, a computer readable medium is included, the computer readable medium having a computer program stored thereon. The computer program for execution by processor 142 is for optimizing drilling. The computer program includes instructions for building a multi-layer DNN from input drilling data. The computer program also includes instructions for extracting a plurality of drilling parameter features from geological data using the DNN. The computer program further includes instructions for building a linear regression model based on the extracted plurality of drilling parameter features. Lastly, the computer program includes instructions for applying the linear regression model to predict one or more drilling parameters. The programming of the computer program for execution by processor 142 may further be accomplished using known programming techniques for implementing the embodiments as described and discussed herein. Still further, the drilling operation can be advantageously optimized in conjunction with knowledge of optimized controllable drilling parameters, as discussed further herein below.

In a preferred embodiment, the geological data includes at least rock strength. In an alternate embodiment, the geological data may further include any of the following: log data, lithology, porosity, and shale plasticity.

Input device 148 can be used for inputting specifications of proposed drilling equipment for use in the drilling of the well bore (or interval of the well bore). In a preferred embodiment, the specifications include at least a bit specification of a recommended drill bit. In an alternate embodiment, the specifications may also include one or more specifications of the following equipment which may include down hole motor, top drive motor, rotary table motor, mud system, and mud pump. Corresponding specifications may include a maximum torque output, a type of mud, or mud pump output rating, for example, as would be appropriate with respect to a particular drilling equipment.

In a preferred embodiment, the predicted drilling mechanics can include bit wear, mechanical efficiency, power, and operating parameters. In another embodiment, the operating parameters can include weight-on-bit (WOB), rotary RPM (revolutions-per-minute), cost, rate of penetration, and torque. The rate of penetration further includes an instantaneous rate of penetration (ROP) and an average rate of penetration (ROP-AVG).

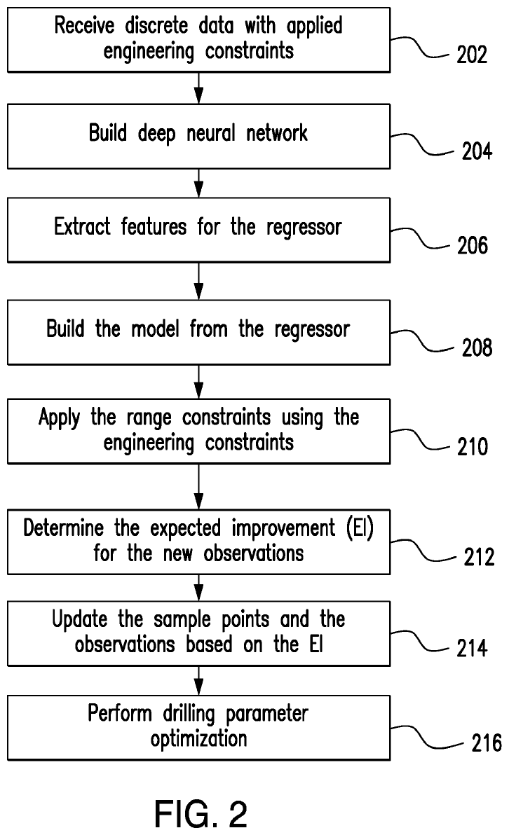

FIG. 2 is a flow diagram for optimizing drilling performed by the drilling system of FIG. 1, in accordance with an embodiment of the present invention. Before turning to the description of FIG. 2, it is noted that the flow diagram in this figure shows example in which operational steps are carried out in a particular order, as indicated by the lines connecting the blocks, but the various steps shown in this diagram can be performed in any order, or in any combination or sub-combination. It should be appreciated that in some embodiments some of the steps described below may be combined into a single step. In some embodiments, one or more additional steps may be performed.

The drilling control system 140 starts the disclosed process at step 202 by receiving discrete drilling related data with designed engineering constraints. In some embodiments, such data may be stored in a database (not shown), which may be part of the drilling control system 140. Non-limiting embodiments of the discrete drilling related data include WOB, RPM, and drilling fluid flowrate. These drilling parameters are generally known and may be constant.

At step 204, the received discrete data can then be input by the drilling control system 140 to a neural network module, which may be executing on site (e.g., within the processor 142) or at a remote location. The neural network module can include any of a deep neural network (DNN), a convolutional neural network (CNN), a Long Short-Term Memory (LSTM) memory block, a time-convolutional neural network (TCNN), a time-frequency CNN (TFCNN), and a fused CNN (fCNN), some of which will be discussed below.

The neural network module can then be used to extract drilling parameter features from the input data for a regressor at step 206. Non-limiting embodiments of the regressor include a linear regressor, Support Vector Machine (SVM) with a Radial Basis Function (RBF) kernel or a polynomial. Support Vector Machines are conventionally utilized for machine learning classification, and a large family of kernel functions is available for specific problem classes. SVMs are relatively robust trainers and are numerically stable for the most popular kernel functions. In some embodiments, the drilling control system 140 employs an SVM with a kernel defined by a radial basis function of the form:

$$K ( x , {x}^{′} ) = exp ( - \frac{{‖ x - {x}^{′} ‖}^{2}}{2 {σ}^{2}} )$$

where x, x′ are the feature vectors and 6 is a free parameter.

At step 208, the drilling control system 140 builds or otherwise generates a mathematical model from the regressor. The generated mathematical model represents the structure of the drill string and forces acting on the drill string. It can be appreciated that various types of mathematical models may be used having various levels of fidelity or complexity in representing the drill string. In one or more embodiments, a mathematical model including statistical interaction terms is fitted to observed data using Bayesian linear regression techniques, wherein prior knowledge is used to determine posterior probability distributions of the model. The term “Bayesian linear regression” refers to an approach to linear regression in which the statistical analysis is undertaken within the context of Bayesian inference. The prior belief function for the linear regression model, including the prior probability distribution function of the model's parameter, is combined with the data's likelihood function according to Bayes theorem to yield the posterior probability distribution about the parameters.

At step 210, the drilling control system 140 applies a constrained data range using the engineering constraints (step 202) to predict one or more drilling parameters. For example, to avoid bottomhole assembly tool vibrations, certain ranges of RPM need to be avoided for a given WOB. This and other drilling best practices may provide the range constraint for the optimization. Next, at step 212, the drilling control system 140 maximizes the multivariate expected improvement (EI) values for the new observations. In one embodiment, new observations are to be compared with the current best predicted value of the one or more drilling parameters x, found as the parameter value setting that maximizes a new multivariate EI for Bayesian optimization, given by the following Equation (1):

$${EI}_{B O} = σ {\int }_{- ∞}^{{f}_{min}^{′}} ( {f}_{min}^{′} - z ) φ ( z ) dz = σ [ ( {f}_{min}^{′} Φ ( {f}_{min}^{′} ) + φ ( {f}_{min}^{′} ) ) ] \qquad ( 1 )$$

where Φ(f′ₘᵢₙ) is the cumulative distribution function, Φ(f′ₘᵢₙ) is the probability density function

$${f}_{min}^{′} = \frac{{f}_{min} - μ}{σ} , z = \frac{y - μ}{σ} ,$$

μ is the mean and σ is the variance.

At step 214, the drilling control system 140 updates at least the sample points and the observations based on the maximized expected improvement determined at step 212. Subsequently, the drilling control system 140 automatically updates values of one or more drilling parameters based on the maximized expected improvement value (step 216). Examples of such controllable drilling parameters include, but are not limited to, WOB, drilling fluid flow through the drill pipe, the drill string rotational speed, and the density and viscosity of the drilling fluid. In summary, the drilling control system 140 performs steps 202-216 to monitor a particular characteristic of the downhole operation as it is being performed over each of the plurality of operating intervals and adjusts one or more operational parameters in order to optimize the downhole operation with respect to the particular characteristic being monitored.

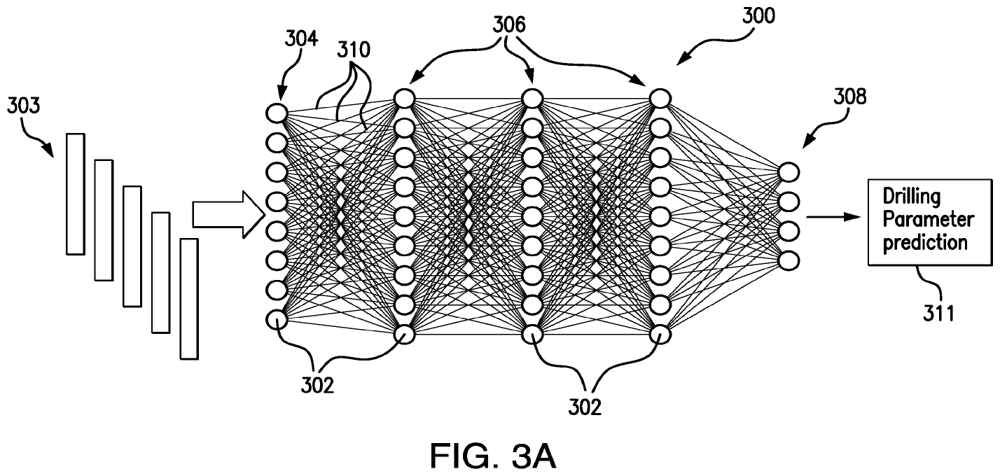

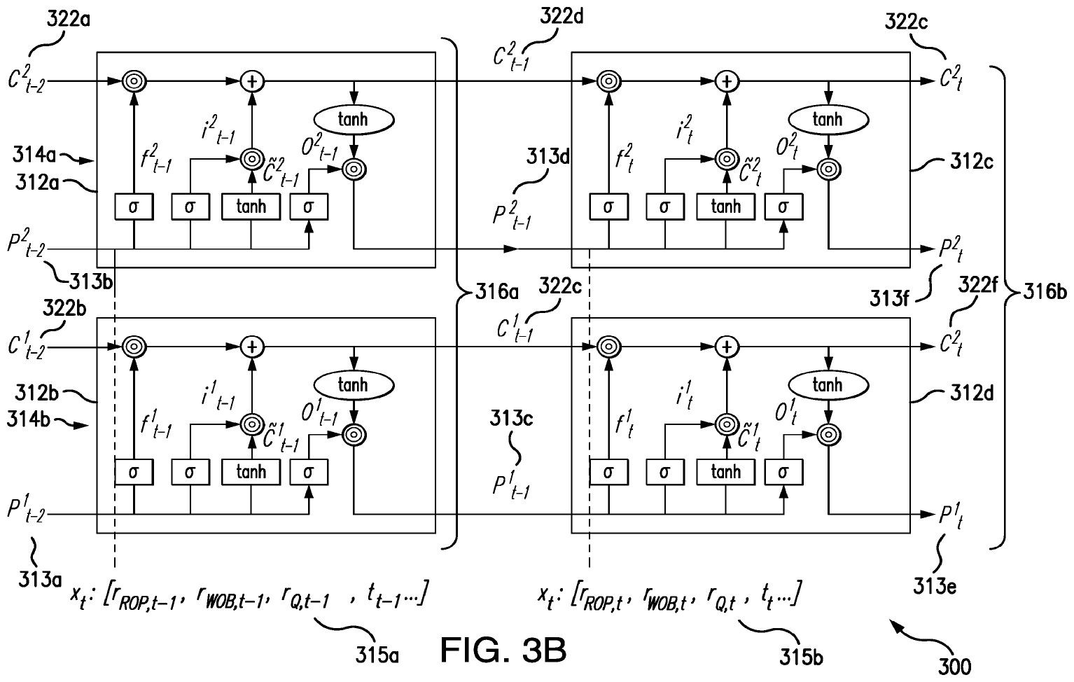

FIG. 3A illustrates an exemplary fully-connected deep neural network (DNN) 300 that can be implemented in accordance with embodiments of the present disclosure. The DNN 300 includes a plurality of nodes 302, organized into an input layer 304, a plurality of hidden layers 306, and an output layer 308. Each of the layers 304, 306, 308 is connected by node outputs 310. It will be understood that the number of nodes 302 shown in each layer 304, 306, 308 is meant to be exemplary, and are in no way meant to be limiting. Accordingly, the number of nodes 302 in each layer can vary between 1000 to 2000 nodes 302. Similarly, the number of hidden layers 306 illustrated is again meant to be exemplary and can vary between four and six hidden layers 306. Additionally, although the illustrated DNN 300 is shown as fully-connected, the DNN 300 could have other configurations, including a partially-connected configuration.

As an overview of the DNN 300, one or more feature vectors 303 can be inputted into the nodes 302 of the input layer 304. Each of the nodes 302 may correspond to a mathematical function having adjustable parameters. All of the nodes 302 may be the same scalar function, differing only according to possibly different parameter values, for example. Alternatively, the various nodes 302 could be different scalar functions depending on layer location, input parameters, or other discriminatory features. By way of example, the mathematical functions could take the form of sigmoid functions. It will be understood that other functional forms could additionally or alternatively be used. Each of the mathematical functions may be configured to receive an input or multiple inputs, and, from the input or multiple inputs, calculate or compute a scalar output. Taking the example of a sigmoid function, each node 302 can compute a sigmoidal nonlinearity of a weighted sum of its inputs.

As such, the nodes 302 in the input layer 304 take in the feature vectors 303 and then produce the node outputs 310, which are sequentially delivered through the hidden layers 306, with the node outputs 310 of the input layer 304 being directed into the nodes 302 of the first hidden layer 306, the node outputs 310 of the first hidden layer 306 being directed into the nodes 302 of the second hidden layer 306, and so on. Finally, the nodes 302 of the final hidden layer 306 can be delivered to the output layer 308, which can subsequently output the prediction 311 for the particular controlled drilling parameter(s).

Prior to run-time usage of the DNN 300, the DNN 300 can be trained with labeled or transcribed data, including one or more drilling parameters. For example, during training, a predicted drilling parameter value 311 may be labeled or previously transcribed. As such, the prediction 311 can be applied to the DNN 300, as described above, and the node outputs 310 of each layer, including the prediction 311, can be compared to the expected or “true” output values.

As illustrated, the DNN 300 is considered “fully-connected” because the node output 310 of each node 302 of the input layer 304 and the hidden layers 306 is connected to the input of every node 302 in either the next hidden layer 306 or the output layer 308. As such, each node 302 receives its input values from a preceding layer 304, 306, except for the nodes 302 in the input layer 304 that receive the feature vectors 303 from the feature extraction module 202, as described above.

In another exemplary embodiment, the DNN 300 may be implemented as a Long Short-Term Memory (LSTM) memory block. Each LSTM memory block can include one or more LSTM memory cells and each LSTM memory cell can generate a cell output that is aggregated to generate the LSTM output for the time step. FIG. 3B depicts a schematic representation of connections between stacked LSTM cells 312a, 312b constituting a deep Recurrent Neural Network in accordance with an embodiment of the present disclosure.

In FIG. 3B, pₜ represents a drilling parameter variable (such as ROP) at various time steps. More specifically, p¹ₜ₋₂ 313a and p²ₜ₋₂ 313b represent drilling parameter values at time step t-2, 313c and p²ₜ₋₁ 313d represent drilling parameter values at time step t-1 and p¹ₜ 313e and p¹ₜ 313f represent drilling parameter values at time step t. Input x 315 is then passed to the deep LSTM recurrent neural network to perform drilling parameters prediction. The present embodiments as described have been observed to provide a predictive system that achieves higher accuracy than conventional predictive systems. In the embodiment shown in FIG. 3B, the input x 315 includes instantaneous rate of penetration (r_{ROP}), Weight On Bit (r_{WOB}), and flow rate (r_{Q}) and is shared by all stacked layers 312a and 312b. Each horizontal row 314a, 314b of the LSTM cells 312a, 312b shows a deep RNN layer, and each vertical section 316a, 316b represents an individual time step.

According to an embodiment of the present invention, the cell state C 322 and the generated predicted output (variable p 313) from an individual layer in the deep RNN is passed on to the next step in the same layer and provides the basis for input formulation at the next time step. In other words, the cell states c¹ₜ₋₁ 322c and c²ₜ₋₁ 322d and the generated predicted variable output p¹ₜ₋₁ 313c and p²ₜ₋₁ 313d are passed from cells 312a and 312b to respective cells 312c and 312d in the same layers 314a and 314b. Final value of the drilling parameter p (e.g., instantaneous rate of penetration) is obtained by combining the predicted variable outputs p¹ₜ 313e and p²ₜ 313f from all stacked layers 314a-314b at the last time step 316b. In various embodiments, the respective outputs may be combined using either root-mean-square error loss and/or BPTT (back propagation through time) methods known in the art, among others. Thus, a deep learning based prediction model, such as the stacked LSTM or other variants of deep RNN (depending on implementation), helps capture highly non-linear variations in the time-series data. This property of the deep learning based prediction model makes it well suited for real-time prediction of one or more drilling parameters based on information collected during multi stage drilling operations.

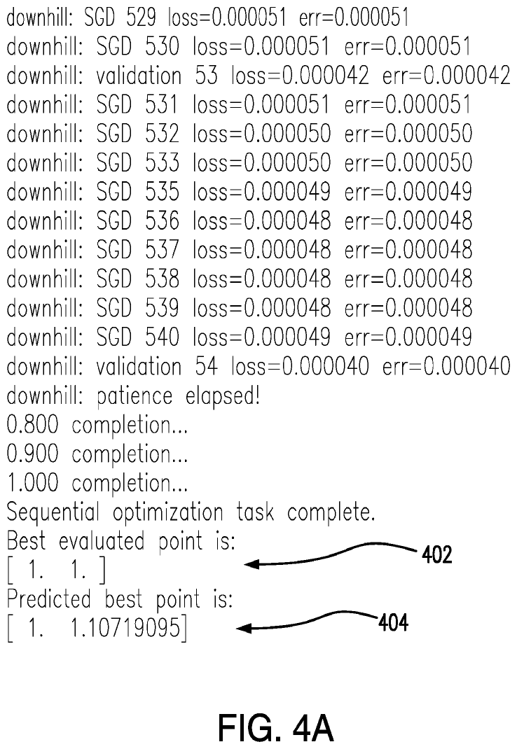

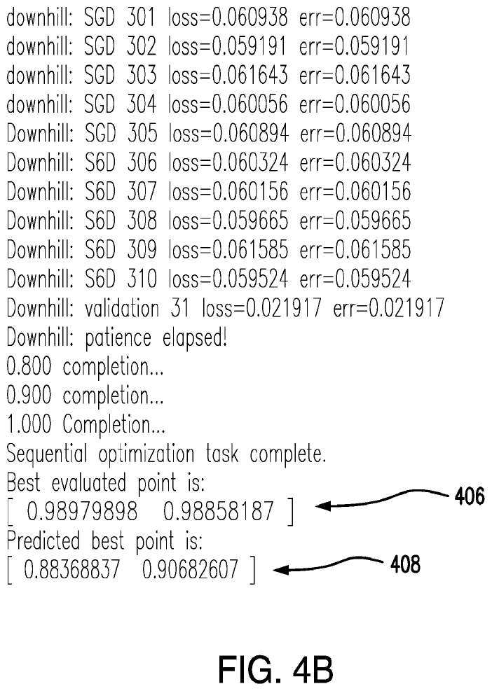

FIGS. 4A and 4B illustrate a comparison between actual optimum drilling parameter value and predicted optimum drilling parameter value or best point, in accordance with embodiments of the present disclosure. FIG. 4A shows the comparison between the actual and the predicted best point with no range constraints. As shown in FIG. 4A, the prediction 311 calculated by the drilling control system 140 is very close to the actual optimum value of the drilling operating parameter. The predicted value 404 of the drilling operating parameter (e.g., ROP) is 1.1, while the actual optimum value 402 of the drilling operating parameter is 1.0. According to an embodiment of the present invention, the drilling control system 140 calculates the predicted value of ROP using the following Equation (2):

ROP=(WOB*RPM)^{1.12}.

FIG. 4B shows the comparison between the actual and the predicted best point with range constraints. The range constraints (applied in step 210) enforce huge gradients which the DNN 300 can capture with more hidden layers 306 and nodes 302. In other words, small changes in the parameters can be enforced using gradient clipping, which controls gradient explosion and employs regularization. Again, according to an embodiment of the present invention, the drilling control system 140 calculates the predicted value of ROP using Equation (1) shown above. In the illustrated example, the drilling control system 140 applied the domain-specific constraints with ROP's zero value between values 0.99 and 1.0. In the illustrated case the actual optimum value 406 is approximately equal to 0.9899 and the predicted value 408 of the drilling operating parameter (e.g., ROP) is 0.9. According to an embodiment of the present invention, the drilling control system 140 may improve the results of the performed prediction by using a hyper optimization technique for the DNN 300.

Accordingly, as set forth above, the embodiments disclosed herein may be implemented in a number of ways. In general, in one aspect, the disclosed embodiments are directed to a method for optimizing drilling. The method includes, among other steps, the steps of (i) building a multi-layer Deep Neural Network (DNN) from real time input drilling data; (ii) extracting a plurality of drilling parameter features from the DNN; (iii) building a linear regression model based on the extracted plurality of drilling parameter features; and (iv) applying the linear regression model to predict one or more drilling parameters.

In one or more embodiments, the method for optimizing drilling may further include any one of the following features individually or any two or more of these features in combination: (a) the step of applying the linear regression model further comprising applying a constrained data range to predict the one or more drilling parameters (b) the DNN comprising a Convolution Neural Network (CNN); (c) the linear regression model comprising a linear Support Vector Machine (SVM) model; (d) the SVM model further comprising a SVM model with a Radial Basis Function (RBF) kernel; and (e) the step of maximizing an expected improvement value based on the linear regression model, the maximum expected improvement corresponds to a predicted value of the one or more drilling parameters.

In general, in yet another aspect, the disclosed embodiments are related to a drilling control system. The system includes a processor and a memory device coupled to the processor. The memory device contains a set of instructions that, when executed by the processor, cause the processor to: (i) build a multi-layer Deep Neural Network (DNN) from real time input drilling data; (ii) extract a plurality of drilling parameter features from the DNN; (iii) build a linear regression model based on the extracted plurality of drilling parameter features; and (iv) apply the linear regression model to predict one or more drilling parameters.

In one or more embodiments, the drilling control system may further include any of the following features individually or any two or more of these features in combination: (a) the set of instructions that causes the processor to apply the linear regression model further causing the processor to apply a constrained data range to predict the one or more drilling parameters; (b) the DNN comprising a Convolution Neural Network (CNN); (c) the linear regression model comprising a linear Support Vector Machine (SVM) model; (d) the SVM model further comprising a SVM model with a Radial Basis Function (RBF) kernel; and (e) the set of instructions that further causes the processor to maximize an expected improvement value based on the linear regression model, the maximum expected improvement corresponds to a predicted value of the one or more drilling parameters.

While particular aspects, implementations, and applications of the present disclosure have been illustrated and described, it is to be understood that the present disclosure is not limited to the precise construction and compositions disclosed herein and that various modifications, changes, and variations may be apparent from the foregoing descriptions without departing from the spirit and scope of the disclosed embodiments as defined in the appended claims.

What is claimed is:

1. A method for optimizing drilling of a well, the method comprising steps of:
building a multi-layer Deep Neural Network (DNN) from real time input drilling data from the well;
extracting a plurality of drilling parameter features from the real time input drilling data using the DNN;
building a linear regression model based on the extracted plurality of drilling parameter features;
applying the linear regression model to the real time input drilling data to predict one or more drilling parameters for the well; and
drilling the well using the one or more drilling parameters.

2. The method of claim 1, wherein the step of applying the linear regression model further comprises applying a constrained data range to the real time input drilling data to predict the one or more drilling parameters.

3. The method of claim 1, wherein the DNN comprises a Convolution Neural Network (CNN).

4. The method of claim 1, wherein the linear regression model comprises a linear Support Vector Machine (SVM) model.

5. The method of claim 4, wherein the SVM model comprises a SVM model with a Radial Basis Function (RBF) kernel.

6. The method of claim 1, further comprising determining an expected improvement value based on the linear regression model, wherein the expected improvement value corresponds to a predicted value of the one or more drilling parameters.

7. The method of claim 1, wherein the one or more drilling parameters comprise one or more of: a Weight On Bit (WOB), a bit Revolutions Per Minute (RPM), flow rate (Q) and Rate of Penetration (ROP).

8. The method of claim 6, further comprising continually updating the one or more drilling parameters based on the expected improvement value in real-time during a drilling operation.

9. A drilling control system for a well, the system comprising a processor and a memory device coupled to the processor, the memory device containing a set of instructions that, when executed by the processor, cause the processor to:
control a downhole tool disposed within the well to obtain real time input drilling data from the well;
build a multi-layer Deep Neural Network (DNN) from the real time input drilling data from the well;
extract a plurality of drilling parameter features from the real time input drilling data using the DNN;
build a linear regression model based on the extracted plurality of drilling parameter features;
apply the linear regression model to the real time input drilling data to predict one or more drilling parameters; and
drill the well using the one or more drilling parameters.

10. The system of claim 9, wherein the set of instructions that causes the processor to apply the linear regression model further causes the processor to apply a constrained data range to the real time input drilling data to predict the one or more drilling parameters.

11. The system of claim 9, wherein the DNN comprises a Convolution Neural Network (CNN).

12. The system of claim 9, wherein the linear regression model comprises a linear Support Vector Machine (SVM) model.

13. The system of claim 12, wherein the SVM model comprises a SVM model with a Radial Basis Function (RBF) kernel.

14. The system of claim 9, wherein the set of instructions further causes the processor to determine an expected improvement value based on the linear regression model, wherein the expected improvement value corresponds to a predicted value of the one or more drilling parameters.

15. The system of claim 9, wherein the one or more drilling parameters comprise one or more of: a Weight On Bit (WOB), a bit Revolutions Per Minute (RPM), flow rate (Q) and Rate of Penetration (ROP).
